(19) United States
(12) Patent Application Publication
(10) Pub. No.: US 2025/0208287 A1
(43) Pub. Date: Jun. 26, 2025

(54) Efficiently Utilizing Fine Timing Measurements Within Large Multi-User Channels

(71) Applicant: Cisco Technology, Inc., San Jose, CA (US)

(72) Inventors: Jerome Henry, Pittsboro, NC (US); Matthew Silverman, Shaker Heights, OH (US); Indermeet Gandhi, San Jose, CA (US); Federico Lovison, Fontanelle (IT); Robert Barton, VANCOUVER (CA); Laurent Alexandre Pierrugues, San Jose, CA (US)

(21) Appl. No.: 18/586,357

(22) Filed: Feb. 23, 2024

Related U.S. Application Data
(60) Provisional application No. 63/614,304, filed on Dec. 22, 2023.

(51) Int. Cl. G01S 13/76; H04W 64/00

(52) U.S. Cl. CPC G01S 13/765; H04W 64/00

(57) ABSTRACT

Described herein are devices, systems, methods, and processes for enhancing fine timing measurement (FTM) within a multi-user (MU) exchange in wireless communication systems. In the embodiments, a client device may perform FTM within a larger, more accurate MU frame, while avoiding the use of the entire bandwidth for the FTM messages. This approach may allow for a more efficient utilization of the available bandwidth. Large channel FTM operations can be reserved with the MU mode, and a temporary association identifier (AID) may be utilized for the client device. Flexibility can be provided in switching between single-user (SU) and MU modes. The embodiments may improve the efficiency and accuracy of FTM in wireless communication systems, offering a lighter and more efficient solution than existing approaches, particularly in high-density environments where a large number of devices may need localization simultaneously.

### CROSS-REFERENCE TO RELATED APPLICATION

This application claims the benefit of U.S. Provisional Patent Application No. 63/614,304, filed Dec. 22, 2023 and entitled “EFFICIENTLY UTILIZING FINE TIMING MEASUREMENTS WITHIN LARGE MULTI-USER CHANNELS,” which is incorporated by reference herein in its entirety.

The present disclosure relates to wireless communication. More particularly, the present disclosure relates to performing time timing measurement (FTM)-based ranging in a multi-user (MU) frame.

### BACKGROUND

Wireless communication systems, such as Wi-Fi networks, often utilize techniques to measure the distance between devices. One such technique is the FTM process. In an FTM process, a client device (e.g., a station (STA)) and an access point (AP) may exchange frames to measure the round-trip time (RTT) of the signal, which can then be utilized to calculate the distance between the devices. The FTM process can be an important component of many wireless communication systems, as it can impact the performance and functionality of the system.

However, the conventional FTM process may have several limitations. By way of a non-limiting example, the accuracy of FTM may increase with the channel width, and one approach to benefit from this effect is to set the Wi-Fi deployment to large channels. While this structure benefits other data communication due to the increased channel width, it can present the downside of causing overlapping basic service set (OBSS) issues in high-density environments. Furthermore, FTM operations may be time-consuming, with a significant number of frames exchanged for each burst, consuming a substantial amount of bandwidth, especially in high-density transitory zones where a large number of devices may need localization simultaneously.

The 802.11az standard attempts to remedy the bandwidth issue by using trigger-based (TB) ranging, where client devices are grouped and send their FTM requests simultaneously. However, this scheme may not be efficient in practice. In practice, a client device performs FTM to a number of APs, then computes its location. The operation can repeat after a short interval if the location result is noisy and at larger intervals if the result is accurate. Therefore, there is no good incentive for a client device to wait for other client devices in a compatible radio frequency (RF) group that may also need to refresh their ranging measurements to a specific AP. Early trials show that client devices tend to opt out of TB groups and perform their individual measurements.

### SUMMARY OF THE DISCLOSURE

Systems and methods for optimizing fine timing measurement (FTM) in multi-user (MU) transmission scenarios in accordance with embodiments of the disclosure are described herein. In some embodiments, a fine timing measurement (FTM) logic is configured to receive an FTM frame via a multi-user (MU) frame, transmit an acknowledgement (ACK) frame based on the MU frame, and calculate a round-trip time (RTT) associated with a network device and the client device based on the FTM frame or the ACK frame.

In some embodiments, the MU frame is received from the network device, and the ACK frame is transmitted to the network device.

In some embodiments, the MU frame is associated with a first transmit time and a first receive time, the ACK frame is associated with a second transmit time and a second receive time, and the RTT is calculated based on one or more of the first transmit time, the first receive time, the second transmit time, or the second receive time.

In some embodiments, the FTM logic is further configured to determine a distance between the network device and the client device based on the RTT.

In some embodiments, the MU frame is associated with a channel bandwidth, and the FTM logic is further configured to determine a quality of the determined distance between the network device and the client device, compare the determined quality of the determined distance to a threshold, and transmit a first FTM request frame to the network device in response to the determined quality of the determined distance being greater than the threshold, the first FTM request frame including an indication of a requested first channel bandwidth that is less than the channel bandwidth.

In some embodiments, the FTM logic is further configured to transmit an FTM request frame to the network device, the FTM request frame including an indication of support for an MU mode.

In some embodiments, the FTM logic is further configured to receive an FTM response frame from the network device, the FTM response frame including an indication of the MU mode.

In some embodiments, the FTM request frame further includes an indication of a requested channel bandwidth that is greater than a threshold.

In some embodiments, the FTM frame occupies a subset of a plurality of resource units (RUs) of the MU frame.

In some embodiments, one or more RUs in the plurality of RUs not occupied by the FTM frame include data destined for one or more other client devices different from the client device.

In some embodiments, the MU frame is associated with a channel bandwidth that is at least 80 MHz.

In some embodiments, the FTM logic is further configured to transmit a first FTM request frame to a first network device, the FTM request frame including an indication of support for an MU mode, receive an FTM response frame from the first network device, the FTM response frame including an indication of the MU mode and an association identifier (AID) for the client device, receive a first FTM frame via a first MU frame from the first network device, transmit a first ACK frame based on the first MU frame to the first network device, and calculate a first RTT associated with the first network device and the client device based on the first FTM frame or the first ACK frame.

In some embodiments, the network device includes an access point.

In some embodiments, a fine timing measurement (FTM) logic is configured to receive an FTM request frame, the FTM request frame including an indication of support for an MU mode at a client device, transmit an FTM response frame, the FTM response frame including an indication of the MU mode for the client device, transmit a multi-user (MU) frame, the MU frame including an FTM frame for the client device, and receive an acknowledgement (ACK) frame based on the MU frame.

In some embodiments, the FTM request frame and the ACK frame are received from the client device.

In some embodiments, the FTM request frame further includes an indication of a requested channel bandwidth that is greater than a threshold.

In some embodiments, the FTM frame occupies a subset of a plurality of resource units (RUs) of the MU frame.

In some embodiments, one or more RUs in the plurality of RUs not occupied by the FTM frame include data destined for one or more other client devices different from the client device.

In some embodiments, the MU frame is associated with a channel bandwidth that is at least 80 MHz.

In some embodiments, wireless ranging includes receiving a fine timing measurement (FTM) frame via a multi-user (MU) frame, transmitting an acknowledgement (ACK) frame based on the MU frame, and calculating a round-trip time (RTT) associated with a network device and a client device based on the FTM frame or the ACK frame.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a diagram illustrating a network setup in accordance with various embodiments of the disclosure;

FIG. 3 is a diagram illustrating a sequence of fine timing measurement (FTM) exchanges between a client device and an access point (AP) in accordance with various embodiments of the disclosure;

FIG. 4 is a flowchart showing a process for performing FTM exchanges in accordance with various embodiments of the disclosure;

FIG. 5 is a flowchart showing a process for performing FTM exchanges in accordance with various embodiments of the disclosure;

FIG. 6 is a flowchart showing a process for performing FTM exchanges in accordance with various embodiments of the disclosure;

FIG. 7 is a flowchart showing a process for performing FTM exchanges in accordance with various embodiments of the disclosure;

FIG. 8 is a flowchart showing a process for performing FTM exchanges in accordance with various embodiments of the disclosure; and

FIG. 9 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that enable fine timing measurement (FTM) within a multi-user (MU) exchange in wireless communication systems. The embodiments may increase the channel bandwidth for the FTM process while decreasing (or without increasing) the basic service set (BSS) airtime consumed by the FTM exchange. In many embodiments, a client device can associate with an access point (AP) (which may be referred to as AP 1), and may expect to perform FTM exchanges with multiple APs (which may be referred to as AP 1 through AP n). Accordingly, in the FTM exchanges, the client device can be the initiator station (ISTA), and the APs may be the responder stations (RSTAs). In a number of embodiments, the client device can discover the multiple APs through a conventional scanning operation.

In a variety of embodiments, the initial FTM request (IFTMR) frame from the client device may include an additional field indicating support by the client device for MU operations. This capability can be distinct from the narrower trigger-based (TB) responder capability bit in the 802.11az standard. In some embodiments, when the field indicating support by the client device for MU operations is included in the IFTMR frame, the client device may become part of the MU sounding pool for the AP (i.e., the RSTA) receiving the IFTMR frame.

In more embodiments, the AP can reserve the large channel FTM operations to the MU mode. In other words, in such embodiments, the large channel FTM operations may be available through just the MU mode, and FTM operations in the single-user (SU) mode can be limited to narrow channel FTM operations. In additional embodiments, a bandwidth of or greater than 80 MHz may be referred to as a large bandwidth, and a channel with a large channel bandwidth can be referred to as a large channel. Conversely, a bandwidth less than 80 MHz may be referred to as a narrow bandwidth, and a channel with a narrow channel bandwidth can be referred to as a narrow channel. Of course, it should be appreciated that the threshold bandwidth (e.g., 80 MHz) is non-limiting. Other suitable threshold bandwidths may also be utilized to distinguish between large bandwidths/channels and narrow bandwidths/channels. In further embodiments, if the IFTMR frame includes the field indicating support for MU operations and requests a large channel, the AP can respond to the IFTMR frame with a response (e.g., an overriding response) frame proposing the MU mode. In still more embodiments, the MU mode may augment the FTM parameters field. In other words, the FTM response frame from the AP can include an FTM parameters field that indicates the MU mode. In still further embodiments, an FTM response frame proposing the MU mode may provide the client device with a choice between a narrower channel (e.g., a narrow channel) in the SU mode and a wider (better) channel (e.g., a large channel) in the MU mode.

In still additional embodiments, for an AP (e.g., an RSTA) not associated with the client device (e.g., AP 2 through AP n) but engaged in FTM exchanges with the client device (e.g., the ISTA), the AP's FTM response to the IFTMR frame can include a temporary (temporal) association identifier (AID) for the client device, along with the other FTM parameters. It should be appreciated that the AP associated with the client device, through the association, has already assigned an AID to the client device prior to any FTM exchanges. In some more embodiments, the AP (whether or not in association with the client device) may utilize the AID in the null data packet announcement (NDPA) frame, to query for the beamforming feedback from the client device.

In certain embodiments, as part of the FTM exchanges (in particular, as part of an FTM burst), the AP can send the FTM frame to the client device while utilizing an MU frame of a large bandwidth (e.g., a bandwidth of 80 MHz, 160 MHz, or 320 MHz, etc.). Utilizing a large bandwidth may enhance the estimation accuracy of the frame preamble arrival time at the client device, thereby improving the precision of the ranging measurement. In yet more embodiments, the FTM request MAC portion (e.g., FTM data) can utilize just a small portion (e.g., one or more resource units (RUs)) of the MU frame. In still yet more embodiments, consistent with the MU operation, the other RUs in the MU frame not taken up by the FTM request MAC portion for the client device may carry data destined for other client devices or MAC FTM request segments for other client devices (e.g., ISTAs) also performing FTM-based ranging. Such an MU/FTM frame can be referred to as “punctured,” because it employs a wide band preamble for increased time estimation accuracy, yet it transmits FTM data over just a portion of the bandwidth, specifically the RUs assigned to the downlink flow to the client device.

In many further embodiments, the client device may acknowledge the MU frame including the FTM frame according to conventional approaches to acknowledging an MU frame. In particular, the client device can acknowledge the MU frame including the FTM frame utilizing a block acknowledgement (ACK). In many additional embodiments, for any subsequent FTM frame in the same FTM burst, the AP may send the subsequent FTM frame in a subsequent MU frame, including the T1/T4 timers. In still yet further embodiments, at any appropriate point of the FTM exchanges described herein, the AP can exit the MU mode, and may send an SU FTM frame to the client device, particularly when there is no downlink traffic to be sent to other client devices. Similarly, in still yet additional embodiments, after an FTM burst is completed, in the next IFTMR frame for the next FTM burst, the client device may change modes, e.g., from the MU mode to the SU mode (or from the SU mode to the MU mode).

In several embodiments, the client device can change modes (e.g., between the SU and MU modes, and/or between channels with different channel bandwidths) based on the accuracy obtained in the previous round of FTM exchanges. If the previous ranging to an AP provided satisfactory accuracy (e.g., determined based on resolving the distance matrix to the multiple APs into a final position of the client device), the client device may attempt a narrower channel (and/or the SU mode). Conversely, if the previous ranging to an AP did not provide satisfactory accuracy, the client device may attempt a wider channel (and/or the MU mode).

In several more embodiments, when the client device is in the SU mode, the IFTMR from the client device, the FTM frames from the AP, and the associated ACK frames from the client device can be sent over a channel other than the primary 20 MHz channel (e.g., the secondary 20 MHz channel in the primary 40 MHz channel). In numerous embodiments, if the client device previously received a sounding null data packet (NDP) frame from the AP, the client device may choose the channel that offers the best stability (instead of always utilizing the primary 20 MHz channel) for the FTM exchanges.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom very large-scale integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

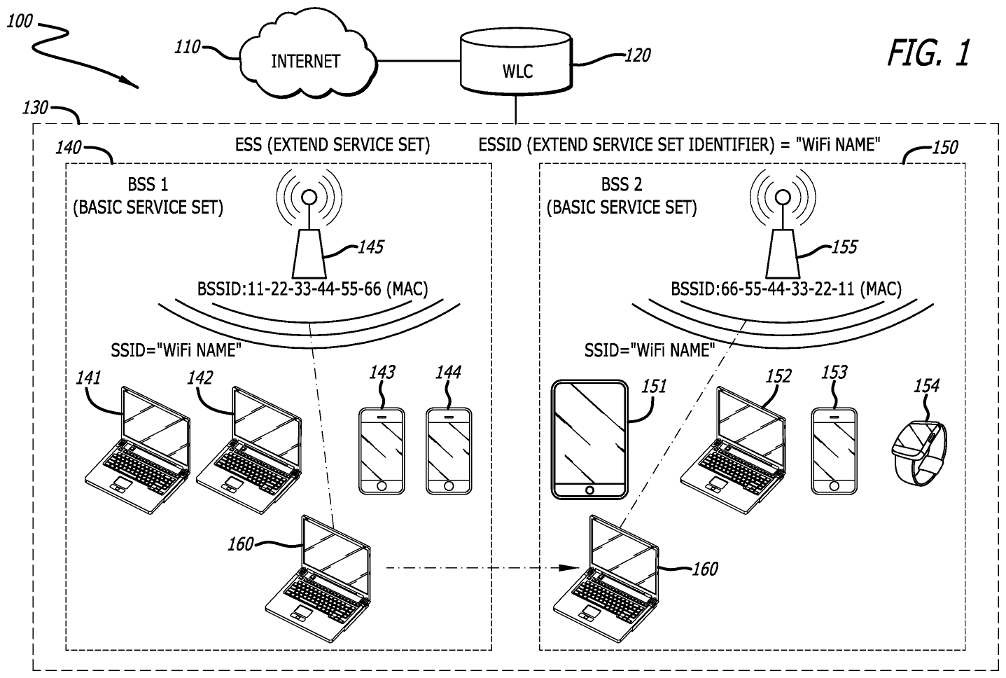

Referring to FIG. 1, a schematic block diagram of a wireless local networking system 100, in accordance with various embodiments of the disclosure is shown. Wireless local networking standards play a crucial role in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments, Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

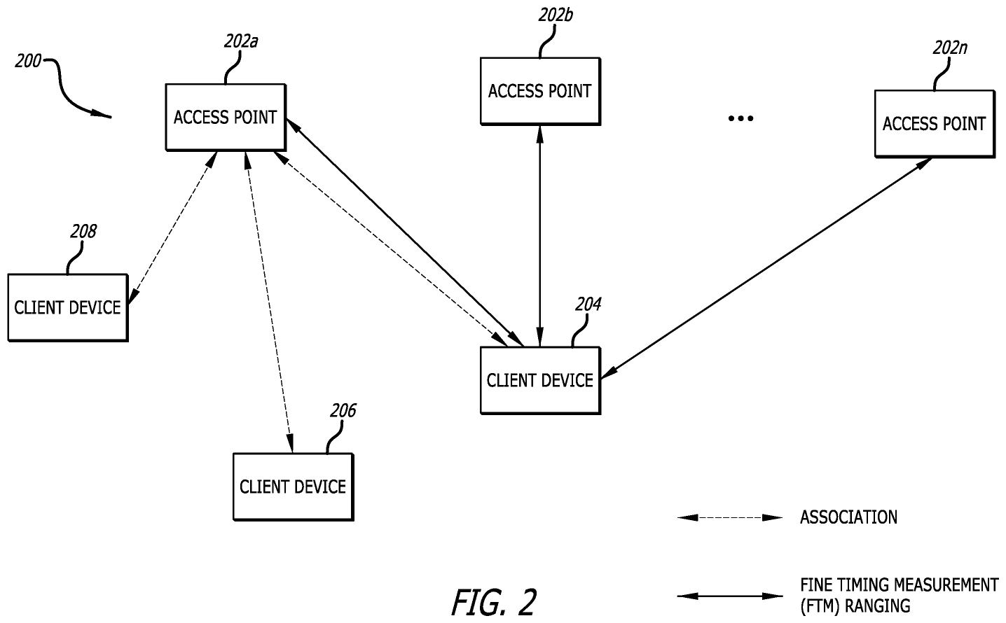

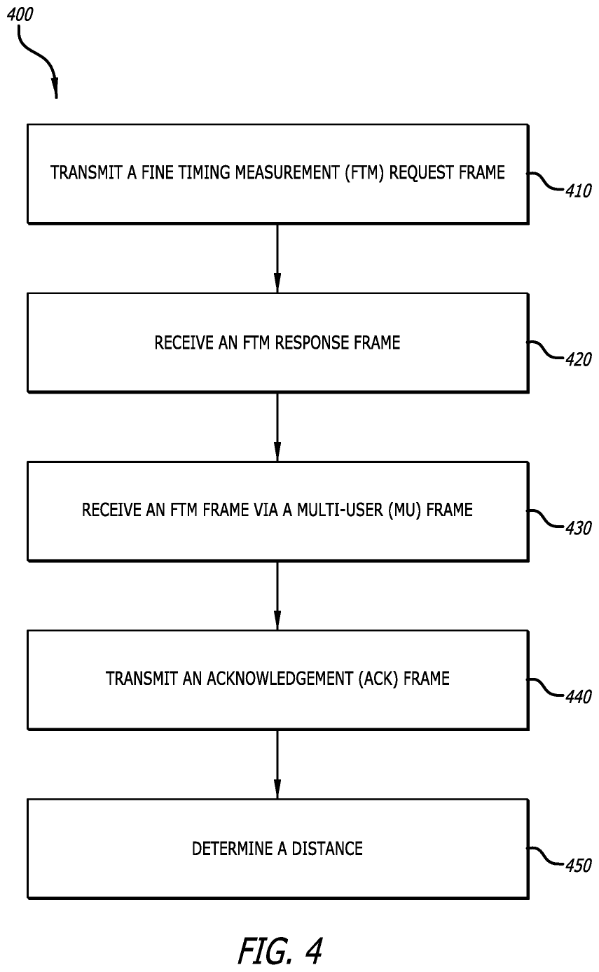

The network can include a variety of user end devices that connect to the network. These devices can sometimes be referred to as stations (i.e., “STAs”). Each device is typically configured with a medium access control (“MAC”) address in accordance with the IEEE 802.11 standard. As described in more detail in FIG. 2, a physical layer can also be configured to communicate over the wireless medium. As described in more detail of FIG. 4, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “WiFi Name”, which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-9 as required to realize a particularly desired embodiment.

Referring to FIG. 2, a diagram illustrating a network setup 200 in accordance with various embodiments of the disclosure is shown. In the embodiments depicted in FIG. 2, multiple APs 202a, 202b, . . . , 202n, and client devices 204, 206, and 208 may be present. The client devices 204, 206, and 208 can be associated with the AP 202a. In many embodiments, the client device 204 can discover the multiple APs 202a, 202b, . . . , 202n through a conventional scanning operation. In a number of embodiments, the client device 204 may initiates FTM exchanges with multiple APs 202a, 202b, . . . , 202n.

In a variety of embodiments, the IFTMR frames from the client device 204 may include a field indicating support by the client device 204 for MU operations. In some embodiments, upon receiving such an IFTMR frame from the client device 204, the AP 202a can deem the client device 204 to be part of an MU sounding pool that further includes the client devices 206 and 208 (and potentially further client devices). In more embodiments, the AP 202a can reserve the large channel FTM operations to the MU mode. In other words, in such embodiments, the large channel FTM operations may be available through just the MU mode, and FTM operations in the SU mode can be limited to narrow channel FTM operations.

In additional embodiments, if the IFTMR frame from the client device 204 includes the field indicating support for MU operations and requests a large channel, the AP 202a can respond to the IFTMR frame with a response (e.g., an overriding response) frame proposing the MU mode. In further embodiments, the FTM response frame from the AP 202a can include an FTM parameters field that indicates the MU mode. In still more embodiments, an FTM response frame proposing the MU mode may provide the client device 204 with a choice between a narrower channel (e.g., a narrow channel) in the SU mode and a wider (better) channel (e.g., a large channel) in the MU mode. In still further embodiments, the client device 204 can choose to utilize the large channel in the MU mode.

In still additional embodiments, the AP 202a may obtain the beamforming feedback from the client device 204 based on NDPA and NDP frames. In particular, the AP 202a can utilize the AID for the client device 204 in the NDPA frame to query for the beamforming feedback. In some more embodiments, as part of the FTM exchanges (in particular, as part of an FTM burst), the AP 202a can send the FTM frame to the client device 204 while utilizing an MU frame of a large bandwidth (e.g., a bandwidth of 80 MHz, 160 MHz, or 320 MHz, etc.). In certain embodiments, the FTM request MAC portion (e.g., FTM data) can utilize just a small portion (e.g., one or more RUs) of the MU frame. In yet more embodiments, consistent with the MU operation, the other RUs in the MU frame not taken up by the FTM request MAC portion for the client device 204 may carry data for other client devices (e.g., client devices 206 and 208, and potentially further client devices) or MAC FTM request segments for other client devices (e.g., ISTAs) also performing FTM-based ranging to the AP 202a.

In still yet more embodiments, the client device 204 may acknowledge the MU frame including the FTM frame according to conventional approaches to acknowledging an MU frame. In particular, the client device 204 can acknowledge the MU frame including the FTM frame utilizing a block ACK. In many further embodiments, for any subsequent FTM frame in the same FTM burst, the AP 202a may send the subsequent FTM frame in a subsequent MU frame, including the T1/T4 timers. Although the FTM ranging process to the AP 202a has been described in more detail above, in many additional embodiments, the FTM ranging processes to the other APs 202b, . . . , 202n, as between the client device 204 and each of the APs 202b, . . . , 202n, can proceed substantially similarly to the FTM ranging process to the AP 202a, especially to the extent one or more of the APs 202b, . . . , 202n also support the MU mode. In still yet further embodiments, for APs 202b, . . . , 202n not associated with the client device 204, assuming they also support the FTM process in the MU mode as described in detail herein, each of these AP's FTM response frame to the IFTMR frame can include a respective temporary AID for the client device 204, along with the other FTM parameters. As such, in still yet additional embodiments, each of the APs 202b, . . . , 202n can utilize the respective AID for the client device 204 in the respective NDPA frame to query for the beamforming feedback from the client device 204.

Although a specific embodiment for a network setup suitable for carrying out the various steps, processes, methods, and operations described herein is discussed with respect to FIG. 2, any of a variety of systems and/or processes may be utilized in accordance with embodiments of the disclosure. For example, the network setup may include a central server coordinating the FTM exchanges between the client devices and the APs. The elements depicted in FIG. 2 may also be interchangeable with other elements of FIGS. 1 and 3-9 as required to realize a particularly desired embodiment.

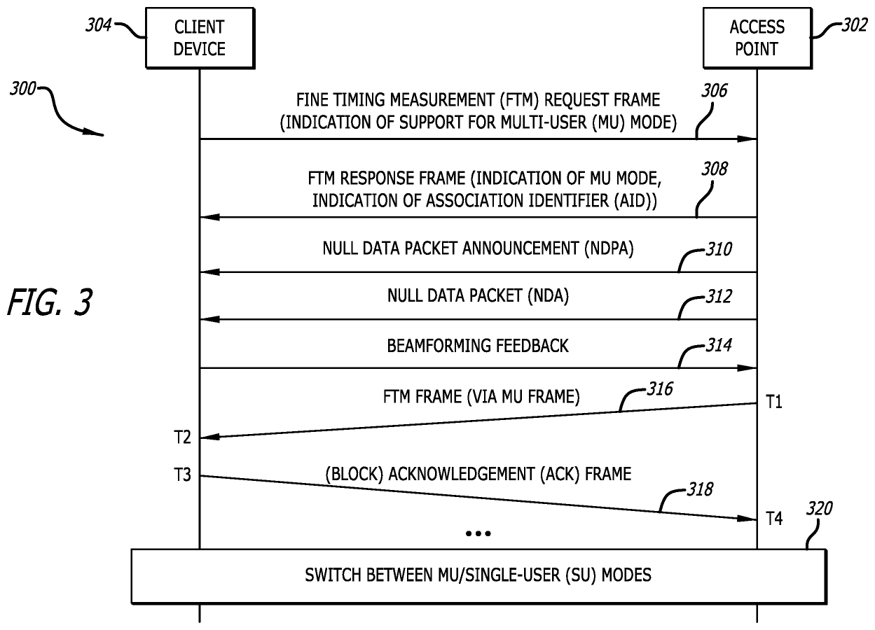

Referring to FIG. 3, a diagram 300 illustrating a sequence of FTM exchanges between a client device and an AP in accordance with various embodiments of the disclosure is shown. In many embodiments, the client device 304 may or may not be associated with the AP 302. In a number of embodiments, the client device 304 may initiate the FTM process by sending an FTM request frame 306 (e.g., an IFTMR frame) to the AP 302. In a variety of embodiments, the FTM request frame 306 can include an indication of support by the client device 304 for the MU mode.

In some embodiments, upon receiving the FTM request frame 306, the AP 302 may respond with an FTM response frame 308. In more embodiments, the FTM response frame 308 can include an indication of the MU mode. In particular, if the FTM request frame 306 includes the field indicating support for MU operations and requests a large channel, the FTM response frame 308 may propose the use of the MU mode for the FTM exchanges. In additional embodiments, if the AP 302 is not associated with the client device 304, the FTM response frame 308 can include a temporary AID for the client device 304, along with the other FTM parameters. In further embodiments, the AP 302 can send an NDPA frame 310 to the client device 304. In still more embodiments, the NDPA frame 310 may include the AID of the client device 304. In still further embodiments, the NDPA frame 310 can be followed by the transmission of an NDP frame 312 from the AP 302. In still additional embodiments, the client device 304 may send a beamforming feedback frame 314 back to the AP 302. The feedback can be utilized by the AP 302 to beamform toward the client device 304.

In some more embodiments, the AP 302 can send an FTM frame 316 to the client device 304 via an MU frame with a large bandwidth (e.g., a bandwidth of 80 MHz, 160 MHz, or 320 MHz, etc.). The time of transmission of the FTM frame 316 may be denoted as T1, and the time of reception at the client device 304 can be denoted as T2. In certain embodiments, the FTM request MAC portion (e.g., FTM data) can utilize just a small portion (e.g., one or more RUs) of the MU frame. In yet more embodiments, consistent with the MU operation, the other RUs in the MU frame not taken up by the FTM request MAC portion for the client device 304 may carry data for other client devices or MAC FTM request segments for other client devices (e.g., ISTAs) also performing FTM-based ranging. In still yet more embodiments, the client device 304 may acknowledge the receipt of the FTM frame 316 by sending an ACK frame 318 back to the AP 302. The time of transmission of the ACK frame 318 can be denoted as T3, and the time of reception at the AP 302 may be denoted as T4. In many further embodiments, the ACK frame 318 can be a block ACK frame. Accordingly, the round-trip time (RTT) between the AP 302 and the client device 304 can be calculated as: T4-T1-(T3-T2). The distance between the AP 302 and the client device 304 may be determined based on the RTT.

In many additional embodiments, additional FTM frames and ACK frames in the same FTM burst, similar to the FTM frame 316 and the ACK frame 318, may be exchanged between the AP 302 and the client device 304 via MU frames. In still yet further embodiments, the RTTs as calculated based on the pairs of FTM frames and ACK frames in the FTM burst can be averaged to derive a final RTT estimate for the FTM burst. In still yet additional embodiments, at 320, either the AP 302 or the client device 304 can switch from the MU mode to the SU mode, or vice versa, as described in detail above. In several embodiments, the client device 304 can change modes (e.g., between the SU and MU modes, and/or between channels with different channel bandwidths) based on the accuracy obtained in the previous round of FTM exchanges (e.g., the previous FTM burst). If the previous ranging to the AP 302 provided satisfactory accuracy (e.g., determined based on resolving the distance matrix to the multiple APs into a final position of the client device 304), the client device 304 may attempt a narrower channel (and/or the SU mode). Conversely, if the previous ranging to an AP 302 did not provide satisfactory accuracy, the client device 304 may attempt a wider channel (and/or the MU mode).

Although a specific embodiment for a sequence of FTM exchanges between a client device and an AP suitable for carrying out the various steps, processes, methods, and operations described herein is discussed with respect to FIG. 3, any of a variety of systems and/or processes may be utilized in accordance with embodiments of the disclosure. For example, the FTM exchanges can be performed with multiple APs simultaneously, with each AP sending its respective FTM frames and receiving its respective ACK frames. The elements depicted in FIG. 3 may also be interchangeable with other elements of FIGS. 1, 2, and 4-9 as required to realize a particularly desired embodiment.

Referring to FIG. 4, a flowchart showing a process 400 for performing FTM exchanges in accordance with various embodiments of the disclosure is shown. In many embodiments, the process 400 may transmit an FTM request frame (block 410). The transmission can be initiated by a client device. In a number of embodiments, the FTM request frame may include an indication of support for an MU mode. In a variety of embodiments, the FTM request frame can also request channel bandwidth (e.g., a large channel bandwidth) for the FTM exchanges.

In some embodiments, the process 400 may receive an FTM response frame (block 420). The FTM response frame can be received from a network device, such as an AP. In more embodiments, the FTM response frame may include an indication of the MU mode (e.g., a proposal to utilize the MU mode for the requested large channel bandwidth). In additional embodiments, the FTM response frame can include a temporary AID for the client device.

In further embodiments, the process 400 may receive an FTM frame via an MU frame (block 430). The MU frame can be received from the network device. In still more embodiments, the MU frame may be transmitted over a large channel bandwidth (e.g., a channel bandwidth that is at least 80 MHz). In still further embodiments, the FTM data can occupy a subset of a plurality of RUs of the MU frame. In still additional embodiments, the FTM frame (via the MU frame) may be associated with a first transmit time and a first receive time.

In some more embodiments, the process 400 may transmit an ACK frame (block 440). The ACK frame can be transmitted in response to the received MU frame. In certain embodiments, the ACK frame may include a block ACK frame that acknowledges the reception of multiple MU frames including the MU frame at block 430. In yet more embodiments, the ACK frame can be associated with a second transmit time and a second receive time.

In still yet more embodiments, the process 400 may determine a distance (block 450). The distance can be between the network device and the client device. The distance can be determined based on the RTT associated with the network device and the client device. In many further embodiments, the RTT may be calculated based on the first transmit time, the first receive time, the second transmit time, and the second receive time. In many additional embodiments, the quality of the determined distance can be compared to a threshold. If the determined quality of the determined distance is satisfactory (e.g., being greater than the threshold), a subsequent FTM request frame may be transmitted to the network device, where the subsequent FTM request can request a different mode (e.g., the SU mode and/or a narrower channel bandwidth).

Although a specific embodiment for performing FTM exchanges suitable for carrying out the various steps, processes, methods, and operations described herein is discussed with respect to FIG. 4, any of a variety of systems and/or processes may be utilized in accordance with embodiments of the disclosure. For example, the process may be implemented in a Wi-Fi mesh network, where multiple APs are interconnected to expand coverage. The elements depicted in FIG. 4 may also be interchangeable with other elements of FIGS. 1-3 and 5-9 as required to realize a particularly desired embodiment.

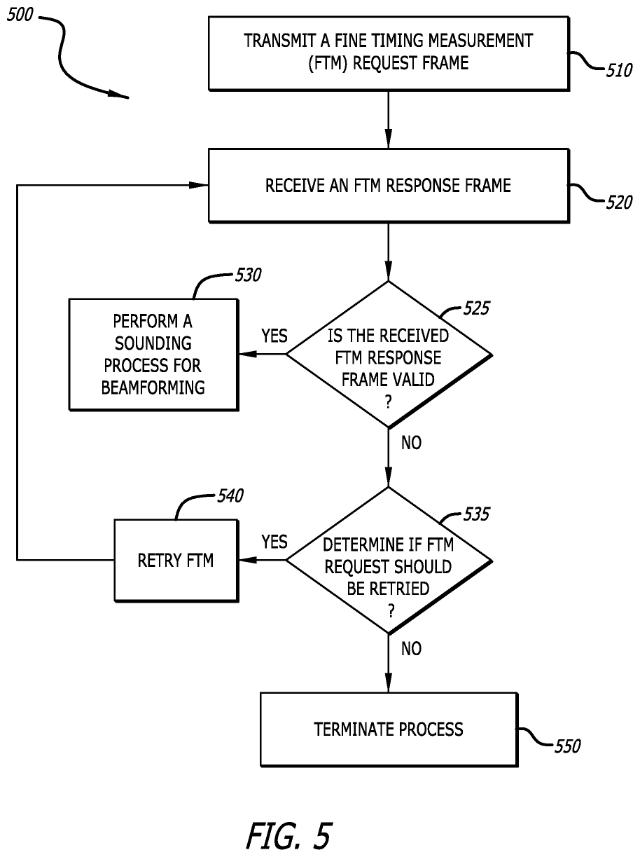

Referring to FIG. 5, a flowchart showing a process 500 for performing FTM exchanges in accordance with various embodiments of the disclosure is shown. In many embodiments, the process 500 may transmit an FTM request frame (block 510). The transmission can be initiated by a client device. In a number of embodiments, the FTM request frame may include an indication of support for an MU mode. In a variety of embodiments, the FTM request frame can also request bandwidth (e.g., a large channel bandwidth) for the FTM exchanges.

In some embodiments, the process 500 may receive an FTM response frame (block 520). The FTM response frame can be received from a network device, such as an AP. In more embodiments, the FTM response frame may include an indication of the MU mode (e.g., a proposal to utilize the MU mode for the requested large channel bandwidth). In additional embodiments, the FTM response frame can include a temporary AID for the client device.

In additional embodiments, the process 500 may determine if the received response frame is valid (block 525). This may include evaluating various parameters and criteria within the received frame to ascertain its authenticity, accuracy, and compliance with predefined standards or protocols. In more embodiments, this may involve verifying the integrity of the transmitted data, checking for any errors or anomalies, ensuring adherence to the expected format and timing constraints, and confirming that the frame originates from an authorized source. If the received response frame is not valid, then a determination is made if the FTM request should be retried (block 535). If it is determined that the FTM process needs to be retried, as indicated by block 540, a return to the step of receiving an FTM response frame is initiated (block 520). In additional embodiments, this may suggest that the initial attempt to receive and process the FTM response frame encountered some form of inadequacy or failure, prompting a reevaluation and subsequent retry. By reverting to the reception stage, the process aims to rectify any issues that may have arisen during the initial attempt, thereby improving the likelihood of successfully obtaining and processing the necessary data for accurate timing measurement. If the FTM request does not need to be retried, then the process may be terminated (block 550).

In further embodiments, the process 500 may perform a sounding process for beamforming (block 530). In still more embodiments, the process can involve the network device sending an NDPA frame and then an NDP frame, and the client device sending a beamforming feedback frame to the network device in response to the NDP frame. In still further embodiments, the NDPA frame may include the AID for the client device. In still additional embodiments, the network device can utilize the beamforming feedback to beamform toward the client device.

Although a specific embodiment for a process of performing FTM exchanges suitable for carrying out the various steps, processes, methods, and operations described herein is discussed with respect to FIG. 5, any of a variety of systems and/or processes may be utilized in accordance with embodiments of the disclosure. For example, the process can be implemented in a Wi-Fi system where the client device is a smart home device and the network device is a home router. The elements depicted in FIG. 5 may also be interchangeable with other elements of FIGS. 1-4 and 6-9 as required to realize a particularly desired embodiment.

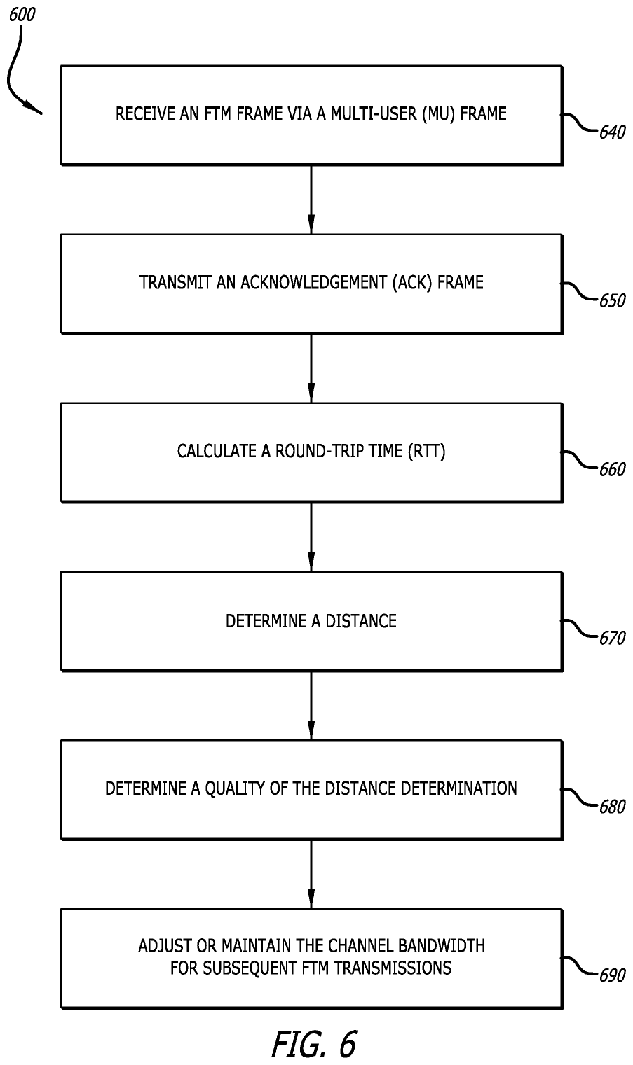

Referring to FIG. 6, a flowchart showing a process 600 for performing FTM exchanges in accordance with various embodiments of the disclosure is shown. In some more embodiments, the process 600 may receive an FTM frame via an MU frame (block 640). The MU frame can be received from the network device. In certain embodiments, the MU frame may be transmitted over a large channel bandwidth (e.g., a channel bandwidth that is at least 80 MHz). In yet more embodiments, the FTM data can occupy a subset of a plurality of RUs of the MU frame. In still yet more embodiments, the FTM frame (via the MU frame) may be associated with a first transmit time and a first receive time.

In many further embodiments, the process 600 may transmit an ACK frame (block 650). The ACK frame can be transmitted in response to the received MU frame. In many additional embodiments, the ACK frame may include a block ACK frame that acknowledges the reception of multiple MU frames including the MU frame at block 640. In still yet further embodiments, the ACK frame can be associated with a second transmit time and a second receive time.

In still yet additional embodiments, the process 600 may calculate an RTT (block 660). The calculation can be based on the times of transmission and reception of the FTM frame and the ACK frame. In particular, in several embodiments, the RTT may be calculated based on the first transmit time, the first receive time, the second transmit time, and the second receive time.

In several more embodiments, the process 600 may determine a distance (block 670). The distance can be between the network device and the client device. In numerous embodiments, the distance may be determined based on the calculated RTT. In particular, this can involve utilizing the speed of light and the calculated RTT to estimate the distance, considering that the radio waves utilized for Wi-Fi communication travel at approximately the speed of light.

In numerous additional embodiments, the process 600 may determine a quality of the distance determination (block 680). In further additional embodiments, the distance matrix to multiple APs can be resolved into a final position of the client device, with the accuracy and/or consistency of the resolved position serving as an indicator of the quality of the distance determination. In some embodiments, the quality of the determined distance can be compared to a threshold to determine whether the quality of the determined distance is satisfactory.

In more embodiments, the process 600 may adjust or maintain the channel bandwidth for subsequent FTM transmissions (block 690). In additional embodiments, if the quality of the determined distance is satisfactory (e.g., greater than the threshold), the process 600 can transmit a subsequent FTM request frame to the network device with a subsequent requested channel bandwidth that is less than the current channel bandwidth. In further embodiments, if the quality of the determined distance is not satisfactory, the process 600 may increase or maintain the channel bandwidth for subsequent FTM transmissions.

Although a specific embodiment for a process of performing FTM exchanges suitable for carrying out the various steps, processes, methods, and operations described herein is discussed with respect to FIG. 6, any of a variety of systems and/or processes may be utilized in accordance with embodiments of the disclosure. For example, the process can be implemented in a Wi-Fi system where the client device is a smart home device and the network device is a home router. The elements depicted in FIG. 6 may also be interchangeable with other elements of FIGS. 1-5 and 7-9 as required to realize a particularly desired embodiment.

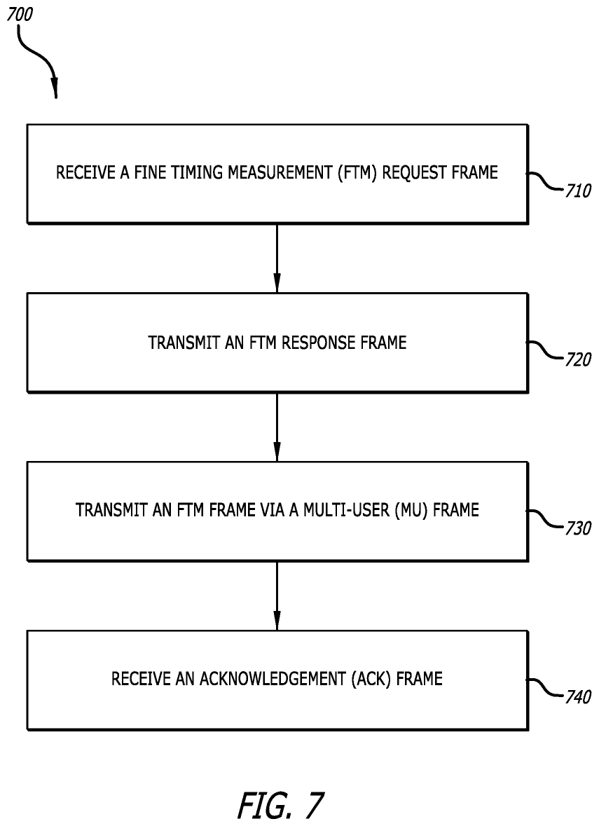

Referring to FIG. 7, a flowchart showing a process 700 for performing FTM exchanges in accordance with various embodiments of the disclosure is shown. In many embodiments, the process 700 may receive an FTM request frame (block 710). The FTM request frame can be received from a client device. In a number of embodiments, the FTM request frame may include an indication of support for an MU mode. In a variety of embodiments, the FTM request frame can also request a channel bandwidth (e.g., a large channel bandwidth) for the FTM exchanges.

In some embodiments, the process 700 may transmit an FTM response frame (block 720). The FTM response frame can be transmitted to the client device. In more embodiments, the FTM response frame may include an indication of the MU mode (e.g., a proposal to utilize the MU mode for the requested large channel bandwidth). In additional embodiments, the FTM response frame can include a temporary AID for the client device.

In further embodiments, the process 700 may transmit an FTM frame via an MU frame (block 730). The MU frame can be transmitted to multiple client devices including the client device. In still more embodiments, the MU frame may be transmitted over a large channel bandwidth (e.g., a channel bandwidth that is at least 80 MHz). In still further embodiments, the FTM data can occupy a subset of a plurality of RUs of the MU frame. In still additional embodiments, the FTM frame (via the MU frame) may be associated with a first transmit time and a first receive time.

In some more embodiments, the process 700 may receive an acknowledgement (ACK) frame (block 740). The ACK frame can be received from the client device. In certain embodiments, the ACK frame may include a block ACK frame that acknowledges the reception of multiple MU frames including the MU frame at block 730. In yet more embodiments, the ACK frame can be associated with a second transmit time and a second receive time.

Although a specific embodiment for performing FTM exchanges suitable for carrying out the various steps, processes, methods, and operations described herein is discussed with respect to FIG. 7, any of a variety of systems and/or processes may be utilized in accordance with embodiments of the disclosure. For example, the process may be implemented in a Wi-Fi system where the network device is an AP in a public venue, and the FTM exchanges are utilized to provide location-based services to the client devices based on their estimated distances from the AP. The elements depicted in FIG. 7 may also be interchangeable with other elements of FIGS. 1-6, and 8-9 as required to realize a particularly desired embodiment.

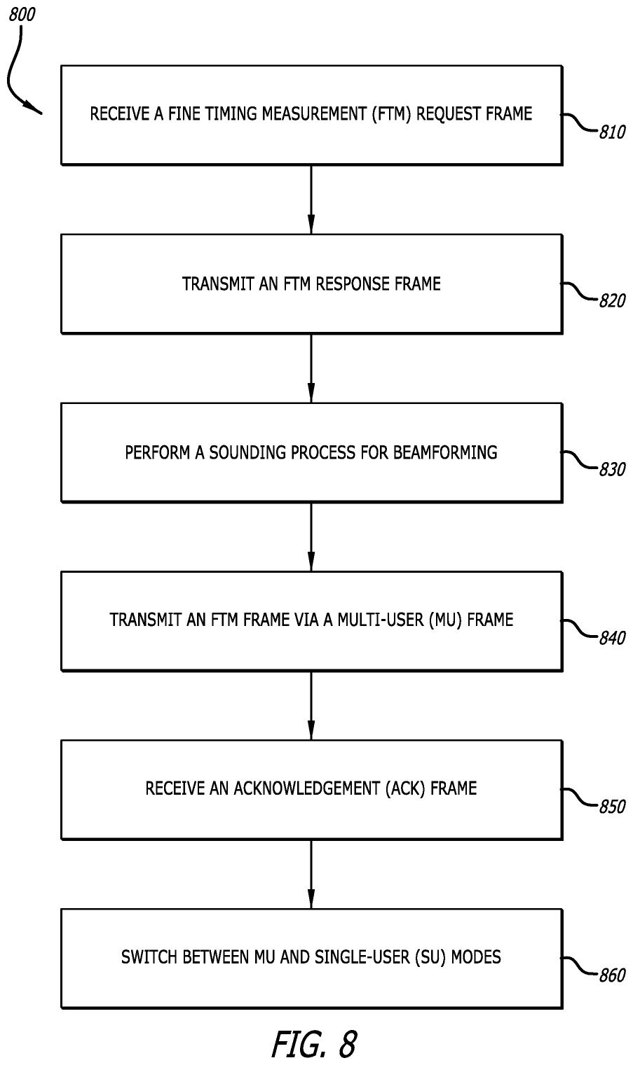

Referring to FIG. 8, a flowchart showing a process 800 for performing FTM exchanges in accordance with various embodiments of the disclosure is shown. In many embodiments, the process 800 may receive an FTM request frame (block 810). The FTM request frame can be received from a client device. In a number of embodiments, the FTM request frame may include an indication of support for an MU mode. In a variety of embodiments, the FTM request frame can also request a channel bandwidth (e.g., a large channel bandwidth) for the FTM exchanges.

In some embodiments, the process 800 may transmit an FTM response frame (block 820). The FTM response frame can be transmitted to the client device. In more embodiments, the FTM response frame may include an indication of the MU mode (e.g., a proposal to utilize the MU mode for the requested large channel bandwidth). In additional embodiments, the FTM response frame can include a temporary AID for the client device.

In further embodiments, the process 800 may perform a sounding process for beamforming (block 830). In still more embodiments, the process can involve the network device sending an NDPA frame and then an NDP frame, and the client device sending a beamforming feedback frame to the network device in response to the NDP frame. In still further embodiments, the NDPA frame may include the AID for the client device. In still additional embodiments, the network device can utilize the beamforming feedback to beamform toward the client device.

In some more embodiments, the process 800 may transmit an FTM frame via an MU frame (block 840). The MU frame can be transmitted to multiple client devices including the client device. In certain embodiments, the MU frame may be transmitted over a large channel bandwidth (e.g., a channel bandwidth that is at least 80 MHz). In yet more embodiments, the FTM data can occupy a subset of a plurality of RUs of the MU frame. In still yet more embodiments, the FTM frame (via the MU frame) may be associated with a first transmit time and a first receive time.

In many further embodiments, the process 800 may receive an ACK frame (block 850). The ACK frame can be received from the client device. In many additional embodiments, the ACK frame may include a block ACK frame that acknowledges the reception of multiple MU frames including the MU frame at block 840. In still yet further embodiments, the ACK frame can be associated with a second transmit time and a second receive time.

In still yet additional embodiments, the process 800 may switch between the MU and SU modes (block 860). This can involve the network device dynamically adjusting its operation based on factors such as, but not limited to, the number of client devices, their capabilities, and the network/channel conditions. In several embodiments, the process 800 may switch from the MU mode to the SU mode when there is no downlink traffic to be sent to other client devices.

Although a specific embodiment for performing FTM exchanges suitable for carrying out the various steps, processes, methods, and operations described herein is discussed with respect to FIG. 8, any of a variety of systems and/or processes may be utilized in accordance with embodiments of the disclosure. For example, the process can be implemented in a Wi-Fi system where the network device is a router in a dense urban environment, and the FTM exchanges are utilized to optimize the network performance under varying traffic conditions and client device distributions. The elements depicted in FIG. 8 may also be interchangeable with other elements of FIGS. 1-7 and 9 as required to realize a particularly desired embodiment.

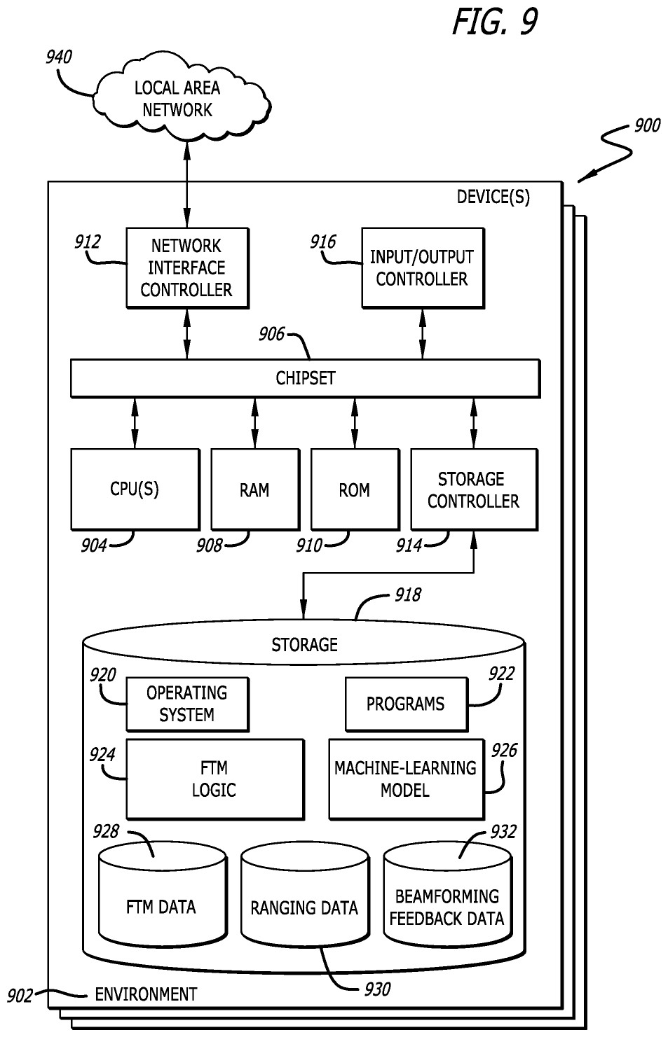

Referring to FIG. 9, a conceptual block diagram for one or more devices 900 capable of executing components and logic for implementing the functionality and embodiments described above is shown. The embodiment of the conceptual block diagram depicted in FIG. 9 can illustrate a conventional server computer, workstation, desktop computer, laptop, tablet, network appliance, e-reader, smartphone, or other computing device, and can be utilized to execute any of the application and/or logic components presented herein. The device 900 may, in some examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In additional embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Different embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for example, store an operating system 920, applications 922, FTM data 928, ranging data 930, and beamforming feedback data 932, which are described in greater detail below. The storage 918 can be connected to the environment 902 through a storage controller 914 connected to the chipset 806. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

For example, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINU8 operating system. According to another embodiment, the operating system comprises the WINDOWS® SERVER operating system from MICROSOFT Corporation of Redmond, Washington. According to further embodiments, the operating system can comprise the UNI8 operating system or one of its variants. It should be appreciated that other operating systems can also be utilized. The storage 918 can store other system or application programs and data utilized by the device 900.

In various embodiment, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-7 and 9. In more embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9, and can include other components that are not explicitly shown in FIG. 9, or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

In many embodiments, the device 900 can include an FTM logic 924. The FTM logic 924 may be configured to manage the FTM exchanges between the client device and the network device. The FTM logic 924 can also be responsible for calculating the RTT based on the FTM frame and the ACK frame, and determining the distance between the client device and the network device based on the RTT.

In a number of embodiments, the storage 918 can include FTM data 928. The FTM data 928 may include the data obtained from the FTM exchanges, such as, but not limited to, the transmit and receive times of the FTM frame and the ACK frame. The FTM data 928 can also include the calculated RTT and the determined distance between the client device and the network device.

In various embodiments, the storage 918 can include ranging data 930. The ranging data 930 may include the calculated distances between the client device and multiple network devices based on the FTM exchanges. The ranging data 930 can also be utilized to estimate the position of the client device within the network by resolving the distance matrix to the multiple network devices.

In still more embodiments, the storage 918 can include beamforming feedback data 932. The beamforming feedback data 932 may include data about the channel conditions between the client device and the network device, which can be utilized for the beamforming process. The beamforming feedback data 932 can also include the client device's feedback on the beamforming by the network device, which can be utilized to adjust the beamforming process.

Finally, in many embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926. The ML model 926 may be configured to analyze the FTM data, ranging data, and beamforming feedback data to predict optimal parameters for future FTM exchanges and beamforming processes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A client device, comprising:
a processor;
at least one network interface controller configured to provide access to a network; and
a memory communicatively coupled to the processor, wherein the memory comprises a fine timing measurement (FTM) logic that is configured to:
receive an FTM frame via a multi-user (MU) frame;
transmit an acknowledgement (ACK) frame based on the MU frame; and
calculate a round-trip time (RTT) associated with a network device and the client device based on the FTM frame or the ACK frame.

2. The client device of claim 1, wherein the MU frame is received from the network device, and the ACK frame is transmitted to the network device.

3. The client device of claim 2, wherein the MU frame is associated with a first transmit time and a first receive time, the ACK frame is associated with a second transmit time and a second receive time, and the RTT is calculated based on one or more of the first transmit time, the first receive time, the second transmit time, or the second receive time.

4. The client device of claim 1, wherein the FTM logic is further configured to determine a distance between the network device and the client device based on the RTT.

5. The client device of claim 4, wherein the MU frame is associated with a channel bandwidth, and the FTM logic is further configured to:
determine a quality of the determined distance between the network device and the client device;
compare the determined quality of the determined distance to a threshold; and
transmit a first FTM request frame to the network device in response to the determined quality of the determined distance being greater than the threshold, the first FTM request frame comprising an indication of a requested first channel bandwidth that is less than the channel bandwidth.

6. The client device of claim 1, wherein the FTM logic is further configured to:
transmit an FTM request frame to the network device, the FTM request frame comprising an indication of support for an MU mode.

7. The client device of claim 6, wherein the FTM logic is further configured to:
receive an FTM response frame from the network device, the FTM response frame comprising an indication of the MU mode.

8. The client device of claim 6, wherein the FTM request frame further comprises an indication of a requested channel bandwidth that is greater than a threshold.

9. The client device of claim 1, wherein the FTM frame occupies a subset of a plurality of resource units (RUs) of the MU frame.

10. The client device of claim 9, wherein one or more RUs in the plurality of RUs not occupied by the FTM frame comprise data destined for one or more other client devices different from the client device.

11. The client device of claim 1, wherein the MU frame is associated with a channel bandwidth that is at least 80 MHz.

12. The client device of claim 1, wherein the FTM logic is further configured to:
transmit a first FTM request frame to a first network device, the FTM request frame comprising an indication of support for an MU mode;
receive an FTM response frame from the first network device, the FTM response frame comprising an indication of the MU mode and an association identifier (AID) for the client device;
receive a first FTM frame via a first MU frame from the first network device;
transmit a first ACK frame based on the first MU frame to the first network device; and
calculate a first RTT associated with the first network device and the client device based on the first FTM frame or the first ACK frame.

13. The client device of claim 1, wherein the network device comprises an access point.

14. A network device, comprising:
a processor;
at least one network interface controller configured to provide access to a network; and
a memory communicatively coupled to the processor, wherein the memory comprises a fine timing measurement (FTM) logic that is configured to:
receive an FTM request frame, the FTM request frame comprising an indication of support for an MU mode at a client device;
transmit an FTM response frame, the FTM response frame comprising an indication of the MU mode for the client device;
transmit a multi-user (MU) frame, the MU frame comprising an FTM frame for the client device; and
receive an acknowledgement (ACK) frame based on the MU frame.

15. The network device of claim 14, wherein the FTM request frame and the ACK frame are received from the client device.

16. The network device of claim 14, wherein the FTM request frame further comprises an indication of a requested channel bandwidth that is greater than a threshold.

17. The network device of claim 14, wherein the FTM frame occupies a subset of a plurality of resource units (RUs) of the MU frame.

18. The network device of claim 17, wherein one or more RUs in the plurality of RUs not occupied by the FTM frame comprise data destined for one or more other client devices different from the client device.

19. The network device of claim 14, wherein the MU frame is associated with a channel bandwidth that is at least 80 MHz.

20. A method for wireless ranging, comprising:
receiving a fine timing measurement (FTM) frame via a multi-user (MU) frame;
transmitting an acknowledgement (ACK) frame based on the MU frame; and
calculating a round-trip time (RTT) associated with a network device and a client device based on the FTM frame or the ACK frame.
